(19) United States
(12) Patent Application Publication
(10) Pub. No.: US 2005/0018229 A1
(43) Pub. Date: Jan. 27, 2005

(54) System and method for enhanced printing capabilities using a print job manager function

(75) Inventors: Carl Phillip Gusler, Austin, TX (US); Rick Allen Hamilton II, Charlottesville, VA (US); James Wesley Seaman, Falls Church, VA (US); Timothy Moffett Waters, Richmond, VA (US)

Correspondence Address: Rudolf O. Siegesmund, Suite 2000, 4627 N. Central Expressway, Dallas, TX, 75205-4017, US

(73) Assignee: International Business Machines Corporation, Armonk, NY (US)

(21) Appl. No.: 10/626,193

(22) Filed: Jul. 24, 2003

(51) Int. Cl. G06F 15/00

(52) U.S. Cl. 358/1.13; 358/1.15; 358/1.9

(57) ABSTRACT

A methodology for printing a document on a plurality of printers is disclosed. The present invention comprises a Classification Program (CP), a Specific Printer Program (SPP), a Color Printer Program (CPP), and a Black/White Printer Program (B/WPP). The CP analyzes each page of the document to determine where to send the page. The SPP, CPP, and B/WPP compile the pages from the printer holding queues to form a print job, compare the print job to a printer page threshold, and separate the print job if necessary. The SPP, CPP, and B/WPP also analyze the available printers to determine the printer with the shortest wait time and send the print job to the appropriate printer. The document may then be reassembled from the various printers to produce a finished document which was printed in considerably less time than the prior art printing methods.

### FIELD OF THE INVENTION

The present invention is directed generally to a method for printing documents and specifically to an improved method for distributing a document to a plurality of printers based on the document's printing requirements.

### BACKGROUND OF THE INVENTION

The need to perform basic administrative duties as quickly as possible drives the need for tools that improve office productivity. In many offices, one major bottleneck that workers face is the printer. When printer resources are limited, the ability to maximize printer productivity is critical to improving efficiency. However, as the quality of documents increases with more specialized fonts, enhanced color graphics, and new document macros, the print jobs in the print queues are becoming larger causing the print queues to become longer. Moreover, as documents become more specialized, the ability of a single printer to handle the entire document decreases. Therefore, a need exists for a method for printing a single print job correctly and efficiently.

The prior art method of printing a complex print job is to send the entire document to a single printer. If the printer already has a print queue with numerous print jobs, the print time for the last queued document can be extensive. This problem is further compounded when one or more of the pages of the document contain color based graphics in encapsulated post-script format, complex macros, sophisticated fonts, and/or embedded graphics. These specialized document images may not be printed properly if the printer receiving the job does not have the required capabilities. For example, if a document containing pages with color text or images is queued to a black and white printer, then the desired effect of the colors in the document is lost. Additionally, the text may not be processed properly if a specific printer is not postscript and/or graphic capable. In another example, documents containing digital photographs may not be acceptable if the photographic images are not printed on photographic paper. Therefore, a need exists for a method of printing a complex document on a plurality of normal and specialty printers.

The prior art has addressed the problem of print manager control of multiple printers. For example, U.S. Pat. No. 5,327,526 (the '526 patent) entitled “Print Job Control System” discloses a method of printing a plurality of documents in which the documents are printed according to a predefined priority indicator. The method disclosed in the '526 patent continuously manipulates the order of the print jobs to insure that the highest priority jobs are printed before the lower priority jobs. However, the '526 patent does not disclose a method of dividing print jobs based on the characteristics of the print jobs. The '526 patent also does not disclose a method for dividing a print job among a plurality of printers. Therefore, a need exists for a method of separating a print job and sending the document to a plurality of printers.

U.S. Pat. No. 5,547,178 (the '178 patent) entitled “Printer Mailbox Split Jobs Overflow Banner Sheet Indicator System” discloses a job splitting program. The method of the '178 patent breaks the print job into multiple print jobs when the print jobs exceeds the maximum capacity of the sorting bin in the copier. However, the '178 patent is limited to separating print jobs based on external characteristics (the copier bin capacity). The '178 patent does not disclose a method of separating print jobs based on the internal document characteristic, that is the characteristics of the document to be printed. The '178 patent also does not disclose a method for dividing a print job among a plurality of printers. Therefore, a need exists for a method of separating a print job based on document characteristics and sending the document to a plurality of printers.

U.S. Pat. No. 5,859,711 (the '711 patent) entitled “Multiple Print Engine with Virtual Job Routing” discloses a method for distributing a print job to multiple printers. The method disclosed in the '711 patent sends the print jobs to multiple print engines then reassembles the document. However, the '711 patent does not disclose an orderly method for separating the document and selecting the printers based on the time required to print each print job. Therefore, a need exists in the art for a method of separating a print job based on the printing needs of the document and sending the document to a plurality of printers based on the time to print a section of the document at each of the plurality of printers.

Consequently, a need exists in the art for a method and apparatus for analyzing a document and separating the document based on the internal document characteristics. Furthermore, a need exists in the art for a method of sending the separated document to a plurality of printers. Finally, a need exists in the art for a method of determining the most efficient routing method for a document based on the print queue of a plurality of printers and the specific document characteristics.

### SUMMARY OF THE INVENTION

The present invention, which meets the needs stated above, is a methodology for separating a document, sending the document pages to a plurality of different printers based on the document page characteristics, and reassembling the document. The software embodiment of the present invention comprises a Classification Program (CP), a Specific Printer Program (SPP), a Color Printer Program (CPP), and a Black/White Printer Program (B/WPP). The CP analyzes the metadata in each page of the document to determine if the page should be sent to a specific printer, a color printer, or a black/white printer. The CP separates the document, places each page in a holding queue for the appropriate printer, and runs the SPP, CPP, and B/WPP. The SPP compiles the pages from the specific printer holding queue to form a print job, compares the print job to a specific printer page threshold, and separates the print job into a plurality of print jobs if necessary. The SPP also analyzes the available specific printers to determine the specific printer with the shortest wait time and sends the print job to the appropriate printer. The CPP compiles the pages from the color printer holding queue to form a print job, compares the print job to a color printer page threshold, and separates the print job into a plurality of print jobs if necessary. The CPP also analyzes the available color printers to determine the color printer with the shortest wait time and sends the print job to the appropriate printer. The B/WPP compiles the pages from the black/white printer holding queue to form a print job, compares the print job to a black/white printer page threshold, and separates the print job into a plurality of print jobs if necessary. The B/WPP also analyzes the available black/white printers to determine the black/white printer with the shortest wait time and sends the print job to the appropriate printer. The document may then be reassembled from the various printers to produce a finished document which was printed in considerably less time than the prior art printing methods.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is an illustration of a computer memory and processor associated with the present invention;

FIG. 3 is an illustration of the Classification Program (CP) of the present invention;

FIG. 4 is an illustration of the Specific Printer Program (SPP) of the present invention;

FIG. 5 is an illustration of the Color Printer Program (CPP) of the present invention;

FIG. 6 is an illustration of the Black/White Printer Program (B/WPP) of the present invention; and

FIG. 7 is an illustration of the process of printing a document utilizing the present invention.

### DETAILED DESCRIPTION OF THE PREFERRED EMBODIMENT

As used herein, the term “computer” shall mean a machine having a processor, a memory, and an operating system, capable of interaction with a user or other computer, and shall include without limitation desktop computers, notebook computers, personal digital assistants (PDAs), servers, handheld computers, and similar devices.

As used herein, the term “document” means a computer file comprising two or more pages which a user wants to print.

As used herein, the term “metadata” means hidden data in a document describing printable document data. For example, a file header embedded within a document that states that a document contains color graphics, color effects, macros, a specific font, or other specific requirements is metadata. Persons skilled in the art are aware of other types of metadata.

As used herein, the term “print farm profile” means data for at least one printer including the number, size, type, and other properties of print jobs in the print queue for the printer, the printer speed, amount of paper in the printer bin, and other properties concerning the printer.

As used herein, the term “print job” means a document which has been allocated to a printer for printing. The separated pages of a document are sent to a holding queue until the document is fully separated, at which point the pages in the holding queue are compiled into a single print job. A print job may be further separated into two or more print jobs if the print job exceeds a printer page threshold.

As used herein, the term “separate” means to divide the pages of a document or print job into two or more print jobs. Documents are only separated at the page boundaries; individual document pages cannot be separated.

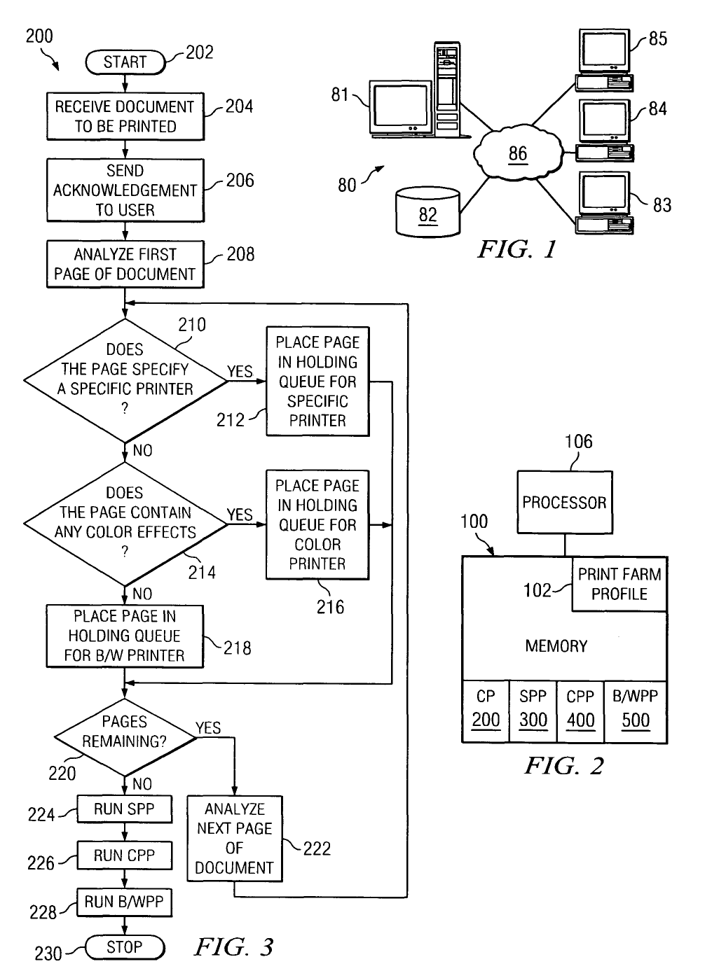

FIG. 1 is an illustration of computer network 80 associated with the present invention. Computer network 80 comprises local machine 85 electrically coupled to network 86. Local machine 85 is electrically coupled to remote machine 84 and remote machine 83 via network 86. Local machine 85 is also electrically coupled to server 81 and database 82 via network 86. Network 86 may be a simplified network connection such as a local area network (LAN) or may be a larger network such as a wide area network (WAN) or the Internet. Furthermore, computer network 80 depicted in FIG. 1 is intended as a representation of a possible operating network that may contain the present invention and is not meant as an architectural limitation.

The internal configuration of a computer, including connection and orientation of the processor, memory, and input/output devices, is well known in the art. The present invention is a methodology that can be embodied in a computer program. Referring to FIG. 2, the methodology of the present invention is implemented on software by Classification Program (CP) 200. CP 200 includes Specific Printer Program (SPP) 300, Color Printer Program (CPP) 400, and Black/White Printer Program (B/WPP) 500. CP 200, SPP 300, CPP 400, and B/WPP 500 described herein can be stored within the memory of any computer depicted in FIG. 1. Alternatively, CP 200, SPP 300, CPP 400, and B/WPP 500 can be stored in an external storage device such as a removable disk, a CD-ROM, or a USB storage device. Memory 100 is illustrative of the memory within one of the computers of FIG. 1. Memory 100 also contains print farm profile 102. The present invention may interface with print farm profile 102 through memory 100. As part of the present invention, the memory 100 can be configured with CP 200, SPP 300, CPP 400, and/or B/WPP 500. Processor 106 can execute the instructions contained in CP 200, SPP 300, CPP 400, and/or B/WPP 500.

In alternative embodiments, CP 200, SPP 300, CPP 400, and/or B/WPP 500 can be stored in the memory of other computers. Storing CP 200, SPP 300, CPP 400, and/or B/WPP 500 in the memory of other computers allows the processor workload to be distributed across a plurality of processors instead of a single processor. Further configurations of CP 200, SPP 300, CPP 400, and/or B/WPP 500 across various memories are known by persons of ordinary skill in the art.

Turning to FIG. 3, the logic of Classification Program (CP) 200 is illustrated. CP 200 is a methodology for separating a document into the pages that contain color graphics, black and white text, or other features suitable for a specific printer. The separation of the document that occurs in CP 200 may optionally be combined with the separation of print jobs that is described in SPP 300, CPP 400, and B/WPP 500. CP 200 starts (202) when a user desires to print a document. CP 200 receives the document to be printed (204). CP 200 sends an acknowledgement back to the computer that originated the document (206). CP 200 then analyzes the first page of the document (208). In analyzing the first page of the document, CP 200 examines the metadata for the first page of the document to determine if the first page of the document contains any color graphics or effects. CP 200 also analyzes the document metadata to determine if the first page contains any fonts, digital photographs, graphics, or other effects that require a specific printer to print the page. Examples of specific printers are printers containing letterhead, photographic printers, and any other printer which is enabled to print fonts or images unprintable by other printers. The document metadata may include any of the following data about the document: document size, document type, text type, text color, graphic type, graphic color, priority of print job, page size, page format characteristics, and/or document resolution requirements. Alternatively, the document metadata may specifically direct a page to a specific printer without indicating the reasons why the page is to be printed on a specific printer. An example of a specific printer direction is directing one or more pages of the document to the closest printer to the user's computer or a printer at a specific location.

CP 200 then makes a determination whether the metadata for the current page specifies a specific printer (210). If the metadata specifies a specific printer for the current page, then CP 200 places the current page in a holding queue for the specific printer (212) and proceeds to step 220. There may possibly be a plurality of specific printer holding queues as some pages may require one type of specific printer while other pages require a different type of specific printer. The holding queue for the specific printer may be in any memory defined by a person of ordinary skill in the art such as cache memory. If at step 210 the metadata for the current page does not specify a specific printer, then CP 200 proceeds to step 214.

At step 214, CP 200 then makes a determination whether the metadata for the current page indicates that there are color effects, graphics, or any other need for a color printer in the current page (214). If the metadata indicates the need for a color printer for the current page, then CP 200 places the current page in a holding queue for the color printer (216) and proceeds to step 220. The holding queue for the color printer may be in any memory defined by a person of ordinary skill in the art such as cache memory. If at step 214 the metadata for the current page does not indicate the need for a color printer, then CP 200 places the page in a holding queue for a black and white printer (218), and proceeds to step 220. The holding queue for the black/white printer may be in any memory defined by a person of ordinary skill in the art such as cache memory.

At step 220 CP 200 determines if there any pages remaining (220). If there are pages remaining, then CP 200 analyzes the next page in the document (222) similar to the analysis in step 208. CP 200 then returns to step 210. Returning to step 220, if CP 200 determines that there are not any pages remaining, then CP 200 runs SPP 300 (224), runs CPP 400 (226), runs B/WPP 500 (228), and ends (230).

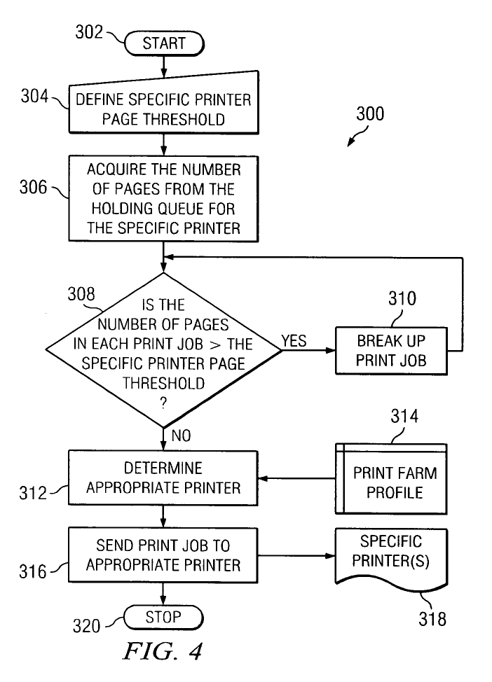

Turning to FIG. 4, the logic of Specific Printer Program (SPP) 300 is illustrated. SPP 300 is a methodology for printing the document pages that are stored in the specific printer holding queue. A document may request a specific printer if the document contains special sophisticated fonts, embedded graphics, or requires very high resolution. Specific printers may also contain a specific paper such as photographic quality (glossy) paper, perforated pages, or company letterhead. Specific printers may also be designated by the user, such as the printer in room 2036. SPP 300 starts (302) when requested by CP 200. SPP 300 then accepts a user definition of a specific printer page threshold (304). The specific printer page threshold is the maximum number of pages to be printed as a single print job on any one printer. If the print job exceeds the specific printer page threshold, then the print job will be separated into a plurality of smaller print jobs. The specific printer page threshold can be stored in memory so that the user does not have to enter a new specific printer page threshold upon every use of the present invention. Alternatively to accepting a user defined specific printer page threshold, SPP 300 can automatically select a specific printer page threshold by a method determined by persons of ordinary skill in the art.

Next, SPP 300 acquires the number of pages from the holding queue for the specific printer (306). SPP 300 compiles these pages into a single print job for the specific printer. If there is a plurality of specific printer holding queues, then SPP 300 creates a print job for each holding queue and repeats the method described herein for each type of specific printer required. SPP 300 then makes a determination whether the number of pages in the current print job is greater than the specific printer page threshold (308). If the number of pages in the current print job is greater than the specific printer page threshold, then SPP 300 separates the print job (310) and returns to step 308. In separating the print job, SPP 300 may divide the print job into two even-sized print jobs. Alternatively, SPP 300 may extract a series of print jobs each less than the specific printer page threshold from the original print job until there are no print jobs exceeding the specific printer page threshold. Persons of ordinary skill in the art are aware of other methods for separating a print job. If at step 308 SPP 300 determines that the number of pages is not greater than the specific printer page threshold, then SPP 300 proceeds to step 312.

At step 312, SPP 300 determines the appropriate printer for the print job(s) (312). In order to determine the appropriate printer, SPP 300 analyzes the print farm profile 314 obtained from memory. Print farm profile 314 may be the print farm profile for only the specific printers or may be a print farm profile for all printers such as print farm profile 102 in FIG. 2. It is likely that there may be a plurality of specific printers and that SPP 300 will have to choose the most appropriate printer(s) for the print job(s) from the available printers. SPP 300 determines the appropriate printer by analyzing the number and size of print jobs queued for each specific printer. SPP 300 calculates the print time for each document in the print queue by dividing the size of each print job by the printer speed For example, if a forty page document is printing on a twenty page per minute (ppm) printer, the document will require two minutes of printer time. The total time until the printer is available may then be calculated by summing the print times for each document in the printer queue. SPP 300 performs this calculation for every specific printer and designates the specific printer with the shortest wait time as the appropriate printer.

The printer with the shortest wait time may not necessarily be the printer with the fewest print jobs in the printer queue and SPP 300 will select a printer with more items in a wait queue and a shorter wait time over a printer with fewer items in the wait queue and a longer wait time. For example, if a first printer is capable of printing at twenty ppm and has two separate forty-page documents in the wait queue, then the first printer will be available in four minutes. By contrast, if a second printer is capable of printing at ten ppm and has five separate two-page documents, then the second printer will be available in one minute. In the preceding example, the second printer is preferable over the first printer because the second printer has a shorter wait time. In an alternative embodiment, SPP 300 can factor the time required to print the current print job into the calculation, which would then produce the time required to print the current print job as opposed to the time until the printer is available. If all of the printers have the same printing speeds, then the assignment of print jobs to printers will not change by calculating the time required to print the current print job. However, if the printers have different print speeds, then the assignment of print jobs to the printers may change by calculating the time required to print the current print job. Recalling the two printer example above, if the current print job is one hundred pages, then the current print job may be printed in nine minutes (four minutes waiting and five minutes printing) on the first printer. By contrast, the same one hundred page document would take eleven minutes to print (one minute waiting plus ten minutes printing) on the second printer, making the first printer the appropriate printer. In a second example, if the current document is only ten pages, then the document will take four and a half minutes to print on the first printer and two minutes to print on the second printer, making the second printer the appropriate printer.

SPP 300 may also determine the appropriate printers for a plurality of print jobs as is the case when the print job is separated into a plurality of print jobs. In this case, SPP 300 designates the printers with the shortest wait times as the appropriate printers. Alternatively, SPP 300 can designate the printers with the shortest print time as the appropriate printers. SPP 300 may also rank the printers based on the wait time for each printer or print time for each print job and assign the largest print job to the printer that will be available first or print the fastest, and continue this processes until all the print jobs have been assigned to the printers. SPP 300 then sends the print job(s) to the appropriate printer(s) 318 (316). If the printed document pages are to be reassembled manually, then SPP 300 will print a control page before the print job on each specific printer. The control page informs the user of the location of the printers that printed the separated parts of the original document. The user can use the control page(s) as instructions for reassembling the document. If the printed document pages are to be assembled by an automated process, then the control pages may not be necessary. SPP 300 then ends (320).

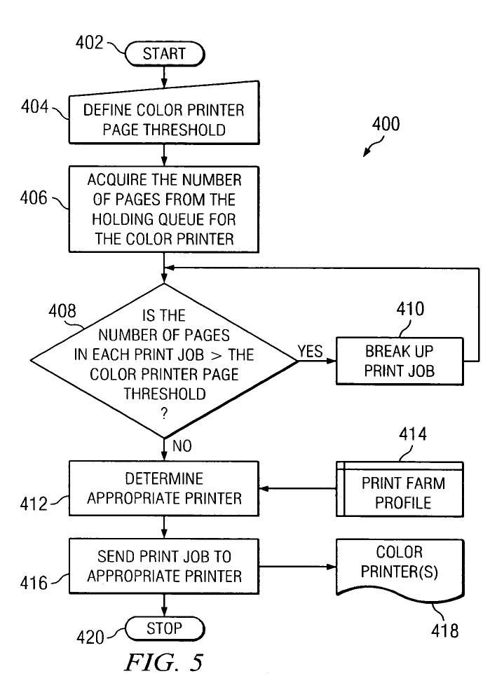

Turning to FIG. 5, the logic of Color Printer Program (CPP) 400 is illustrated. CPP 400 is a methodology for printing the document pages that are stored in the color printer holding queue. CPP 400 starts (402) when requested by CP 200. CPP 400 then accepts a user definition of a color printer page threshold (404). The color printer page threshold is the maximum number of pages to be printed as a single print job on any one printer. If the print job exceeds the color printer page threshold, then the print job will be separated into a plurality of smaller print jobs. The color printer page threshold can be stored in memory so that the user does not have to enter a new color printer page threshold upon every use of the present invention. Alternatively to accepting a user defined color printer page threshold, CPP 400 can automatically select a color printer page threshold by a method determined by persons of ordinary skill in the art.

Next, CPP 400 acquires the number of pages from the holding queue for the color printer (406). CPP 400 compiles these pages into a single print job for the color printer. CPP 400 then makes a determination whether the number of pages in the current print job is greater than the color printer page threshold (408). If the number of pages in the current print job is greater than the color printer page threshold, then CPP 400 separates the print job (410) and returns to step 408. In separating the print job, CPP 400 may divide the print job into two even-sized print jobs. Alternatively, CPP 400 may extract a series of print jobs each less than the color printer page threshold from the original print job until there are no print jobs exceeding the color printer page threshold. Persons of ordinary skill in the art are aware of other methods for separating a print job. If at step 408 CPP 400 determines that the number of pages is not greater than the color printer page threshold, then CPP 400 proceeds to step 412.

At step 412, CPP 400 determines the appropriate printer for the print job(s) (412). In order to determine the appropriate printer, CPP 400 analyzes the color print farm profile 414 obtained from memory. Print farm profile 414 may be the print farm profile for only the color printers or may be a print farm profile for all printers such as print farm profile 102 in FIG. 2. It is likely that there may be a plurality of color printers and that CPP 400 will have to choose the most appropriate printer(s) for the print job(s) from the available printers. CPP 400 determines the appropriate printer by analyzing the number and size of print jobs queued for each color printer. CPP 400 calculates the print time for each document in the print queue by dividing the size of each print job by the printer speed. For example, if a forty page document is printing on a twenty page per minute (ppm) printer, the document will require two minutes of printer time. The total time until the printer is available may then be calculated by summing the print times for each document in the printer queue. CPP 400 performs this calculation for every color printer and designates the color printer with the shortest wait time as the appropriate printer.

The printer with the shortest wait time may not necessarily be the printer with the fewest print jobs in the printer queue and CPP 400 will select a printer with more items in a wait queue and a shorter wait time over a printer with fewer items in the wait queue and a longer wait time. For example, if a first printer is capable of printing at twenty ppm and has two separate forty-page documents in the wait queue, then the first printer will be available in four minutes. By contrast, if a second printer is capable of printing at ten ppm and has five separate two-page documents, then the second printer will be available in one minute. In the preceding example, the second printer is preferable over the first printer because the second printer has a shorter wait time. In an alternative embodiment, CPP 400 can factor the time required to print the current print job into the calculation, which would then produce the time required to print the current print job as opposed to the time until the printer is available. If all of the printers have the same printing speeds, then the assignment of print jobs to printers will not change by calculating the time required to print the current print job. However, if the printers have different print speeds, then the assignment of print jobs to the printers may change by calculating the time required to print the current print job. Recalling the two printer example above, if the current print job is one hundred pages, then the current print job may be printed in nine minutes (four minutes waiting and five minutes printing) on the first printer. By contrast, the same one hundred page document would take eleven minutes to print (one minute waiting plus ten minutes printing) on the second printer, making the first printer the appropriate printer. In a second example, if the current document is only ten pages, then the document will take four and a half minutes to print on the first printer and two minutes to print on the second printer, making the second printer the appropriate printer.

CPP 400 may also determine the appropriate printers for a plurality of print jobs as is the case when the print job is separated into a plurality of print jobs. In this case, CPP 400 designates the printers with the shortest wait times as the appropriate printers. Alternatively, CPP 400 can designate the printers with the shortest print time as the appropriate printers. CPP 400 may also rank the printers based on the wait time for each printer or print time for each print job and assign the largest print job to the printer that will be available first or print the fastest, and continue this processes until all the print jobs have been assigned to the printers. CPP 400 then sends the print job(s) to the appropriate printer(s) 418 (416). If the printed document pages are to be reassembled manually, then CPP 400 will print a control page before the print job on each color printer. The control page informs the user of the location of the printers that printed the separated parts of the original document. The user can use the control page(s) as instructions for reassembling the document. If the printed document pages are to be assembled by an automated process, then the control pages may not be necessary. CPP 400 then ends (420).

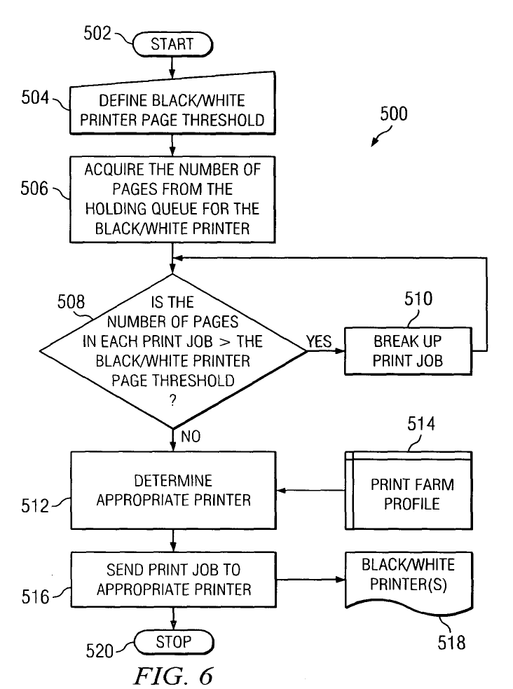

Turning to FIG. 6, the logic of Black/White Printer Program (B/WPP) 500 is illustrated. B/WPP 500 is a methodology for printing the document pages that are stored in the black/white printer holding queue. B/WPP 500 starts (502) when requested by CP 200. B/WPP 500 then accepts a user definition of a black/white printer page threshold (504). The black/white printer page threshold is the maximum number of pages to be printed as a single print job on any one printer. If the print job exceeds the black/white printer page threshold, then the print job will be separated into a plurality of smaller print jobs. The black/white printer page threshold can be stored in memory so that the user does not have to enter a new black/white printer page threshold upon every use of the present invention. Alternatively to accepting a user defined black/white printer page threshold, B/WPP 500 can automatically select a black/white printer page threshold by a method determined by persons of ordinary skill in the art.

Next, B/WPP 500 acquires the number of pages from the holding queue for the black/white printer (506). B/WPP 500 compiles these pages into a single print job for the black/white printer. B/WPP 500 then makes a determination whether the number of pages in the current print job is greater than the black/white printer page threshold (508). If the number of pages in the current print job is greater than the black/white printer page threshold, then B/WPP 500 separates the print job (510) and returns to step 508. In separating the print job, B/WPP 500 may divide the print job into two even-sized print jobs. Alternatively, B/WPP 500 may extract a series of print jobs each less than the black/white printer page threshold from the original print job until there are no print jobs exceeding the black/white printer page threshold. Persons of ordinary skill in the art are aware of other methods for separating a print job. If at step 508 B/WPP 500 determines that the number of pages is not greater than the black/white printer page threshold, then B/WPP 500 proceeds to step 512.

At step 512, B/WPP 500 determines the appropriate printer for the print job(s) (512). In order to determine the appropriate printer, B/WPP 500 analyzes the black/white print farm profile 514 obtained from memory. Print farm profile 514 may be the print farm profile for only the black/white printers or may be a print farm profile for all printers such as print farm profile 102 in FIG. 2. It is likely that there may be a plurality of black/white printers and that B/WPP 500 will have to choose the most appropriate printer(s) for the print job(s) from the available printers. B/WPP 500 determines the appropriate printer by analyzing the number and size of print jobs queued for each black/white printer. B/WPP 500 calculates the print time for each document in the print queue by dividing the size of each print job by the printer speed. For example, if a forty page document is printing on a twenty page per minute (ppm) printer, the document will require two minutes of printer time. The total time until the printer is available may then be calculated by summing the print times for each document in the printer queue. B/WPP 500 performs this calculation for every black/white printer and designates the black/white printer with the shortest wait time as the appropriate printer.

The printer with the shortest wait time may not necessarily be the printer with the fewest print jobs in the printer queue and B/WPP 500 will select a printer with more items in a wait queue and a shorter wait time over a printer with fewer items in the wait queue and a longer wait time. For example, if a first printer is capable of printing at twenty ppm and has two separate forty-page documents in the wait queue, then the first printer will be available in four minutes. By contrast, if a second printer is capable of printing at ten ppm and has five separate two-page documents, then the second printer will be available in one minute. In the preceding example, the second printer is preferable over the first printer because the second printer has a shorter wait time. In an alternative embodiment, B/WPP 500 can factor the time required to print the current print job into the calculation, which would then produce the time required to print the current print job as opposed to the time until the printer is available. If all of the printers have the same printing speeds, then the assignment of print jobs to printers will not change by calculating the time required to print the current print job. However, if the printers have different print speeds, then the assignment of print jobs to the printers may change by calculating the time required to print the current print job. Recalling the two printer example above, if the current print job is one hundred pages, then the current print job may be printed in nine minutes (four minutes waiting and five minutes printing) on the first printer. By contrast, the same one hundred page document would take eleven minutes to print (one minute waiting plus ten minutes printing) on the second printer, making the first printer the appropriate printer. In a second example, if the current document is only ten pages, then the document will take four and a half minutes to print on the first printer and two minutes to print on the second printer, making the second printer the appropriate printer.

B/WPP 500 may also determine the appropriate printers for a plurality of print jobs as is the case when the print job is separated into a plurality of print jobs. In this case, B/WPP 500 designates the printers with the shortest wait times as the appropriate printers. Alternatively, B/WPP 500 can designate the printers with the shortest print time as the appropriate printers. B/WPP 500 may also rank the printers based on the wait time for each printer or print time for each print job and assign the largest print job to the printer that will be available first or print the fastest, and continue this processes until all the print jobs have been assigned to the printers. B/WPP 500 then sends the print job(s) to the appropriate printer(s) 518 (516). If the printed document pages are to be reassembled manually, then B/WPP 500 will print a control page before the print job on each black/white printer. The control page informs the user of the location of the printers that printed the separated parts of the original document. The user can use the control page(s) as instructions for reassembling the document. If the printed document pages are to be assembled by an automated process, then the control pages may not be necessary. B/WPP 500 then ends (520).

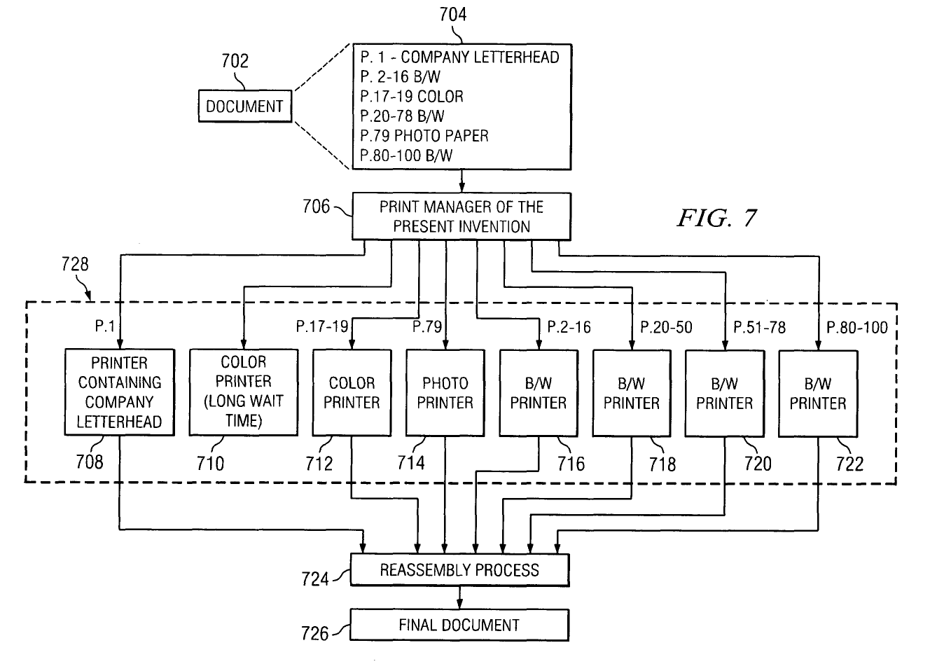

Turning to FIG. 7, the process of printing a document utilizing the present invention is illustrated. A user has indicated a desire to print document 702 by clicking the print button or some similar action. As indicated in box 704, the pages of document 702 require a printer with company letterhead, a color printer, a photo-quality printer, and a black/white printer. The document is sent to the print manger of the present invention 706 which may contain CP 200, SPP 300, CPP 400, and/or B/WPP 500. The print manager separates the documents into components that require a printer containing company letterhead 708, color printers 710 and 712, photo printer 714, and black/white printers 716, 718, 720, and 722. The print manager may decide to send pages 17-19 of the document to color printer 712 instead of color printer 710 due to a long wait time on color printer 710. The print manager may also decide to separate pages 20-78 of the document and send pages 20-50 to black/white printer 718 and pages 51-78 to black/white printer 720. When the pages have printed on the various printers, then the document is reassembled in a reassembly process 724 to produce a finished document 726.

With respect to the above description, it is to be realized that the optimum dimensional relationships for the parts of the invention, to include variations in size, materials, shape, form, function and manner of operation, assembly and use, are deemed readily apparent and obvious to one of ordinary skill in the art, and all equivalent relationships to those illustrated in the drawings and described in the specification are intended to be encompassed by the present invention. The novel spirit of the present invention is still embodied by reordering or deleting some of the steps contained in this disclosure. The spirit of the invention is not meant to be limited in any way except by proper construction of the following claims.

1. A method for printing a document comprising:
analyzing a metadata in a plurality of document pages to determine a required printer type;
separating each of the plurality of document pages into a plurality of print jobs based on the required printer type for each document page;
selecting an appropriate printer for each of the plurality of print jobs; and
printing the plurality of print jobs on the appropriate printers.

2. The method of claim 1 further comprising:
reassembling the plurality of printed print jobs to produce a finished document.

3. The method of claim 1 further comprising:
distributing one of the plurality of document pages to a specific printer holding queue; and
wherein the required printer for the distributed document page is a specific printer.

4. The method of claim 3 wherein the specific printer is a printer containing letterhead.

5. The method of claim 3 wherein the specific printer is a photographic printer.

6. The method of claim 1 further comprising:
distributing one of the plurality of document pages to a color printer holding queue; and
wherein the required printer for the distributed document page is a color printer.

7. The method of claim 1 further comprising:
distributing one of the plurality of document pages to a black/white printer holding queue; and
wherein the required printer for the distributed document page is a black/white printer.

8. The method of claim 1 further comprising:
comparing each print job to a printer page threshold; and
responsive to a determination that the number of document pages in the print job exceeds the printer page threshold, separating print job into a plurality of print jobs.

9. The method of claim 1 wherein the selecting step further comprises:
calculating the time until the printers are available; and
sending the print job to the first available printer.

10. The method of claim 1 wherein the selecting step further comprises:
calculating the time required for the print jobs to print; and
sending the print jobs to the printer with the lowest calculated time required to print the print job.

11. The method of claim 1 wherein the selecting step further comprises:
ranking the printers based on the time until the printers are available; and
assigning the print jobs to the printers based on the printer ranking.

12. The method of claim 1 wherein the selecting step further comprises:
ranking the printers based on the time required for the print jobs to print; and
assigning the print jobs to the printers based on the printer ranking.

13. The method of claim 1 further comprising:
printing a control page with each print job; and
wherein the control page contains printed instructions for reassembling the document.

14. The method of claim 1 wherein the appropriate printer is determined using a print farm profile.

15. A program product operable on a computer, the program product comprising:
a computer-usable medium;
wherein the computer usable medium comprises instructions comprising:
instructions for analyzing a metadata in a plurality of document pages to determine a required printer type;
instructions for separating each of the plurality of document pages into a plurality of print jobs based on the required printer type for each document page;
instructions for selecting an appropriate printer for each of the plurality of print jobs; and
instructions for printing the plurality of print jobs on the appropriate printers.

16. The program product of claim 15 further comprising:
instructions for reassembling the plurality of printed print jobs to produce a finished document.

17. The program product of claim 15 further comprising:
instructions for distributing one of the plurality of document pages to a specific printer holding queue; and
wherein the required printer for the distributed document page is a specific printer.

18. The program product of claim 17 wherein the specific printer is a printer containing letterhead.

19. The program product of claim 17 wherein the specific printer is a photographic printer.

20. The program product of claim 15 further comprising:
instructions for distributing one of the plurality of document pages to a color printer holding queue; and
wherein the required printer for the distributed document page is a color printer.

21. The program product of claim 15 further comprising:
instructions for distributing one of the plurality of document pages to a black/white printer holding queue; and
wherein the required printer for the distributed document page is a black/white printer.

22. The program product of claim 15 further comprising:
instructions for comparing each print job to a printer page threshold; and
responsive to a determination that the number of document pages in the print job exceeds the printer page threshold, instructions for separating print job into a plurality of print jobs.

23. The program product of claim 15 wherein the selecting step further comprises:
instructions for calculating the time until the printers are available; and
instructions for sending the print job to the first available printer.

24. The program product of claim 15 wherein the selecting step further comprises:
instructions for calculating the time required for the print jobs to print; and
instructions for sending the print jobs to the printer with the lowest calculated time required to print the print job.

25. The program product of claim 15 wherein the selecting step further comprises:
instructions for ranking the printers based on the time until the printers are available; and
instructions for assigning the print jobs to the printers based on the printer ranking.

26. The program product of claim 15 wherein the selecting step further comprises:
instructions for ranking the printers based on the time required for the print jobs to print; and
instructions for assigning the print jobs to the printers based on the printer ranking.

27. The program product of claim 17 further comprising:
instructions for printing a control page with each print job; and
wherein the control page contains printed instructions for reassembling the document.

28. The program product of claim 17 wherein the appropriate printer is determined using a print farm profile.

29. A program product operable on a computer, the program product comprising:
a computer-usable medium;
wherein the computer usable medium comprises instructions comprising:
a classification program; and
a plurality of printer programs.

30. The program product of claim 29 wherein the plurality of printer programs comprises a color printer program, a black/white printer program, and a specific printer program.

31. The program product of claim 29 wherein the classification program further comprises:
instructions for analyzing a metadata in a plurality of document pages to determine a required printer type;
instructions for separating each of the plurality of document pages into a plurality of print jobs based on the required printer type for each document page;
instructions for selecting an appropriate printer for each of the plurality of print jobs; and
instructions for printing the plurality of print jobs on the appropriate printers.

32. The program product of claim 31 further comprising:
instructions for reassembling the plurality of printed print jobs to produce a finished document.

33. The program product of claim 31 further comprising:
instructions for distributing one of the plurality of document pages to a specific printer holding queue; and
wherein the required printer for the distributed document page is a specific printer.

34. The program product of claim 33 wherein the specific printer is a printer containing letterhead.

35. The program product of claim 33 wherein the specific printer is a photographic printer.

36. The program product of claim 31 further comprising:
instructions for distributing one of the plurality of document pages to a color printer holding queue; and
wherein the required printer for the distributed document page is a color printer.

37. The program product of claim 31 further comprising:
instructions for distributing one of the plurality of document pages to a black/white printer holding queue; and
wherein the required printer for the distributed document page is a black/white printer.

38. The program product of claim 31 further comprising:
instructions for comparing each print job to a printer page threshold; and
responsive to a determination that the number of document pages in the print job exceeds the printer page threshold, instructions for separating print job into a plurality of print jobs.

39. The program product of claim 31 wherein the selecting step further comprises:
instructions for calculating the time until the printers are available; and
instructions for sending the print job to the first available printer.

40. The program product of claim 31 wherein the selecting step further comprises:
instructions for calculating the time required for the print jobs to print; and
instructions for sending the print jobs to the printer with the lowest calculated time required to print the print job.

41. The program product of claim 31 wherein the selecting step further comprises:
instructions for ranking the printers based on the time until the printers are available; and
instructions for assigning the print jobs to the printers based on the printer ranking.

42. The program product of claim 31 wherein the selecting step further comprises:
instructions for ranking the printers based on the time required for the print jobs to print; and
instructions for assigning the print jobs to the printers based on the printer ranking.

43. The program product of claim 31 further comprising:
instructions for printing a control page with each print job; and
wherein the control page contains printed instructions for reassembling the document.

44. The program product of claim 31 wherein the appropriate printer is determined using a print farm profile.
